(19) United States
(12) Patent Application Publication
(10) Pub. No.: US 2016/0342259 A1
(43) Pub. Date: Nov. 24, 2016

(54) IN-CELL CAPACITIVE TOUCH SCREEN AND DISPLAY DEVICE

(71) Applicant: Shenzhen China Star Optoelectronics Technology Co., Ltd., Shenzhen, Guangdong (CN)

(72) Inventors: Yanjun XIONG, Shenzhen, Guangdong (CN); Xianhua XU, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/425,004

(22) PCT Filed: Jan. 9, 2015
(86) PCT No.: PCT/CN2015/070479

§ 371 Date: Feb. 28, 2015

(30) Foreign Application Priority Data
Dec. 23, 2014 (CN) 201410811074.3

(51) Int. Cl. G06F 3/041; G02F 1/1343; G02F 1/1333; G06F 3/044; G02F 1/1335

(52) U.S. Cl. CPC G06F 3/0416; G06F 3/0412; G06F 3/044; G02F 1/133514; G02F 1/133512; G02F 1/13338; G02F 1/1336; G02F 1/134336; G02F 1/13439; G02F 2203/04; G02F 2201/121

(57) ABSTRACT

An in-cell capacitive touch screen and a display device using the same are provided. The touch screen includes an array substrate having a common electrode layer, a color-filter substrate having an array of filter cells, and a liquid crystal layer. The array substrate may include a pixel cell array corresponding to the array of filter cells of the color-filter substrate. The common electrode layer may include a plurality of driving electrodes extending along a row direction of the pixel cell array. The color-filter substrate may further include a black matrix to interval filter cells in the array of filter cells. The color-filter substrate may further include a plurality of sensing electrodes extending along a column direction of the pixel cell array. The projection of the sensing electrodes on the color-filter substrate overlaps the corresponding columns of the black matrix.

### FIELD OF THE TECHNOLOGY

The present disclosure relates to touch control technology, and more particularly to an in-cell capacitive touch screen and a display device.

### BACKGROUND OF THE DISCLOSURE

As an input medium, a touch screen is a most simple and convenient way for human-computer interaction. Therefore, the touch screen is increasingly being applied to a variety of electronic products. According to different operating principle and information transmission medium, touch screen products can be divided into four categories: infrared touch screens, capacitive touch screens, resistive touch screens and surface acoustic wave touch screens. The capacitive touch screens become mainstream technology of the touch screen, because capacitive touch screens have many advantages, such as long life, high transmittance and multi-touch supportive, etc. In an in-cell capacitive touch screen, touch electrodes are arranged in the screen so as to reduce the thickness of the module, and as a result of reducing the number of structural layers, the screen presents a clearer picture.

In a conventional in-cell capacitive touch screen, two mutually orthogonal strip electrode layers are formed on a thin film transistor (TFT) array substrate. One layer of the two strip electrode layers includes driving electrodes, and the other layer of the two strip electrode layers includes sensing electrodes. As shown in FIG. 1, the conventional in-cell capacitive touch screen includes an array substrate 2, a color-filter substrate 1 having an array of filter cells 4 and disposed opposite to the array substrate 2, and a liquid crystal layer 3 disposed between the array substrate 2 and the color-filter substrate 1. The color-filter substrate 1 further includes a black matrix 5 configured to interval filter cells 4. Two mutually orthogonal strip touch electrode layers are formed on the array substrate successively. The two strip electrode layers include driving electrodes 6 and sensing electrodes 7. A material of the driving electrodes 6 and the sensing electrode 7 is indium tin oxide (ITO, a kind of transparent conductive material). A cross-coupling capacitor C_{M} is formed by an intersection of one driving electrode 6 and one sensing electrode 7, which means, the driving electrode 6 and the sensing electrode 7 respectively constitute two poles of the cross-coupling capacitor C_{M}. When a finger touches the touch screen, the coupling between the two electrodes near the touch point is affected, thereby changing value of the cross-coupling capacitor C_{M} between these two electrodes. When detecting value of the mutual capacitance, driving electrodes emit excitation signals. All of the sensing electrodes receive the signal, so all capacitance value of intersections of the driving electrodes and the sensing electrodes can be got, which means the capacitance value of the entire two-dimensional plane of the touch screen can be got. According to change data of the capacitance value of the entire two-dimensional plane of the touch screen, the coordinates of each touch point can be calculated, and therefore, even if the touch screen has a plurality of touch points, the true coordinates of each touch point also can be calculated.

However, in the conventional in-cell capacitive touch screen mentioned above, two mutually orthogonal strip electrode layers need to be formed on the array substrate, so the process is extremely complicated. In addition, the array substrate includes a thin film transistor array itself with small and complex line, when adding more process steps in the array substrate, the array substrate is easily damaged, and the product yield will be reduced.

### SUMMARY

The present disclosure provides an in-cell capacitive touch screen, by improving the touch electrode structure thereof, the difficulty of preparation process of the touch screen is reduced, product yield is improved, and the cost of production is saved.

To achieve the above object, the present invention adopts the following technical solution.

One aspect of the present disclosure provides an in-cell capacitive touch screen includes an array substrate having a common electrode layer, a color-filter substrate having an array of filter cells and disposed opposite to the array substrate, and a liquid crystal layer sandwiched between the array substrate and the color-filter substrate. The array substrate may include a pixel cell array corresponding to the array of filter cells of the color-filter substrate.

Wherein, the common electrode layer may include a plurality of driving electrodes extending along a row direction of the pixel cell array. In one frame picture display time, the driving electrodes are configured to transmit common electrode signals and touch scanning signals time divisionally.

Wherein, the color-filter substrate may further include a black matrix to interval filter cells in the array of filter cells. The color-filter substrate may further include a plurality of sensing electrodes extending along a column direction of the pixel cell array. The projection of the sensing electrodes on the color-filter substrate overlaps the corresponding columns of the black matrix.

Furthermore, the sensing electrodes and the corresponding columns of the black matrix may be combined into one, thereby the sensing electrodes and the black matrix being in a same layer structure, and the black matrix between two columns of the filter cells is replaced by the sensing electrode.

Furthermore, the touch screen may further include a protecting layer disposed between the color-filter substrate and the liquid crystal layer, wherein the sensing electrodes are disposed on the black matrix, and sandwiched between the color-filter substrate and the protecting layer.

Furthermore, the touch screen may further include a protecting layer disposed between the color-filter substrate and the liquid crystal layer, and wherein the sensing electrodes are disposed on the black matrix and between the liquid crystal layer and the protecting layer.

Furthermore, the sensing electrodes may be metal electrodes.

Furthermore, the metal electrodes may include laminated Mo/Al/Mo metal layers.

Furthermore, the sensing electrodes may be transparent conductive oxide electrodes, and the transparent conductive oxide may be ITO.

Furthermore, a material of the common electrode layer may include ITO.

Furthermore, the array of filter cells may include red filter cells, green filter cells, and blue filter cells.

Another aspect of the present disclosure provides a display device. The display device may include a screen and a backlight module, the screen and the backlight module are disposed opposite to each other, and the backlight module supplying a light source to the screen to make the screen present a picture. The in-cell capacitive touch screen described in the embodiments of the present disclosure may be supplied in the display device.

Compare with the conventional technology, the in-cell capacitive touch screen provided by the present disclosure, have driving electrodes disposed on the array substrate and sensing electrodes disposed on the color-filter substrate. The whole preparation process of the screen only need to add the process for the preparation of driving electrodes, thereby reducing the difficult process of products, improving product yield, and saving the cost of production. In addition, the common electrode layer on the array substrate is divided into a plurality of strips, as driving electrodes, and in one frame picture display time, the driving electrodes are configured to transmit common electrode signals and touch scanning signals time divisionally, thereby reducing the difficult process of products, improving product yield, and saving the cost of production.

### BRIEF DESCRIPTION OF THE DRAWINGS

FIG. 1 is a schematic diagram illustrating a conventional in-cell capacitive touch screen.

FIG. 2 is a schematic diagram illustrating an in-cell capacitive touch screen according to a first embodiment of the present invention.

FIG. 3 is a schematic diagram illustrating an in-cell capacitive touch screen according to a second embodiment of the present invention.

FIG. 4 is a schematic diagram illustrating a display device according to a third embodiment of the present invention.

FIG. 5 is a schematic diagram illustrating an in-cell capacitive touch screen according to a fourth embodiment of the present invention.

### DETAILED DESCRIPTION OF PREFERRED EMBODIMENTS

As previously mentioned, the object of the present disclosure is to provide an in-cell capacitive touch screen, by improving the touch electrode structure thereof, the difficulty of preparation process of the touch screen is reduced. The an in-cell capacitive touch screen provided in the present disclosure includes an array substrate having a common electrode layer, a color-filter substrate having an array of filter cells and disposed opposite to the array substrate, and a liquid crystal layer sandwiched between the array substrate and the color-filter substrate. The array substrate may include a pixel cell array corresponding to the array of filter cells of the color-filter substrate. The common electrode layer may include a plurality of driving electrodes extending along a row direction of the pixel cell array. In one frame picture display time, the driving electrodes are configured to transmit common electrode signals and touch scanning signals time divisionally. The color-filter substrate may further include a black matrix to interval filter cells in the array of filter cells. The color-filter substrate may further include a plurality of sensing electrodes extending along a column direction of the pixel cell array. The projection of the sensing electrodes on the color-filter substrate overlaps the corresponding columns of the black matrix.

In the in-cell capacitive touch screen provided by the present disclosure, the touch electrodes are disposed on different substrates. The driving electrodes are disposed on the array substrate and sensing electrodes are disposed on the color-filter substrate. The whole preparation process of the screen only need to add the process for the preparation of driving electrodes, therefore, the difficult process of products is reduced, the product yield is improved, and the cost of production is saved.

The present disclosure will now be described more specifically with reference to the following embodiments.

### First Embodiment

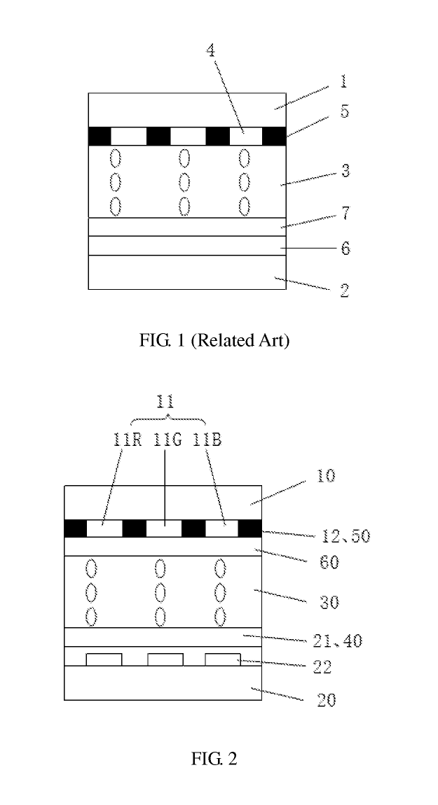

As shown in FIG. 2, an in-cell capacitive touch screen provided by the first embodiment includes an array substrate 20 having a common electrode layer 21, a color-filter substrate 10 having an array of filter cells 11 and disposed opposite to the array substrate 20, and a liquid crystal layer 30 sandwiched between the array substrate 20 and the color-filter substrate 10. The filter cells 11 may include red filter cells 11R, green filer cells 11G and blue filter cells 11B. The array substrate 20 may include a pixel cell array 22 corresponding to the array of filter cells of the color-filter substrate 10. The color-filter substrate 10 may further include a black matrix to interval filter cells 11R, 11G, 11B in the array of filter cells 11. In this embodiment, the in-cell capacitive touch screen further may include a protecting layer 60 between the color-filter substrate 10 and the liquid crystal layer 30.

The touch electrodes of the touch screen may include driving electrodes 40 and sensing electrodes 50.

Specifically, the driving electrodes 40 are disposed in the common electrode layer 21 on the array substrate 20. That is, the common electrode layer 21 is divided into long strips along a row direction of the pixel cell array 22, as the driving electrodes 40 of the touch screen. Furthermore, a material of the common electrode layer 21 may be ITO. Because the driving electrodes 40 are divided from the common electrode layer 21, in one frame picture display time, the driving electrodes 40 may transmit common electrode signals and touch scanning signals time divisionally.

The sensing electrodes 50 are disposed on the color-filter substrate 10. The sensing electrodes 50 extend along a column direction of the pixel cell array 22. In this embodiment, each of the sensing electrodes 50 and the corresponding column of the black matrix 12 are combined into one, thereby the sensing electrodes 50 and the black matrix 12 being in a same layer structure. The black matrix 12 between two columns of the filter cells 11 is replaced by the sensing electrode 50. Furthermore, the sensing electrodes 50 may be metal electrodes. The metal electrodes may include laminated Mo/Al/Mo metal layers.

In the in-cell capacitive touch screen of the exemplary embodiment, the touch electrodes are disposed on different substrates. The driving electrodes are disposed on the array substrate. The sensing electrodes are disposed on the color-filter substrate. The common electrode layer on the array substrate is divided into a plurality of strips, as driving electrodes, and the sensing electrodes and the corresponding columns of the black matrix are combined into one, thereby reducing the difficult process of products, improving product yield, and saving the cost of production.

### Second Embodiment

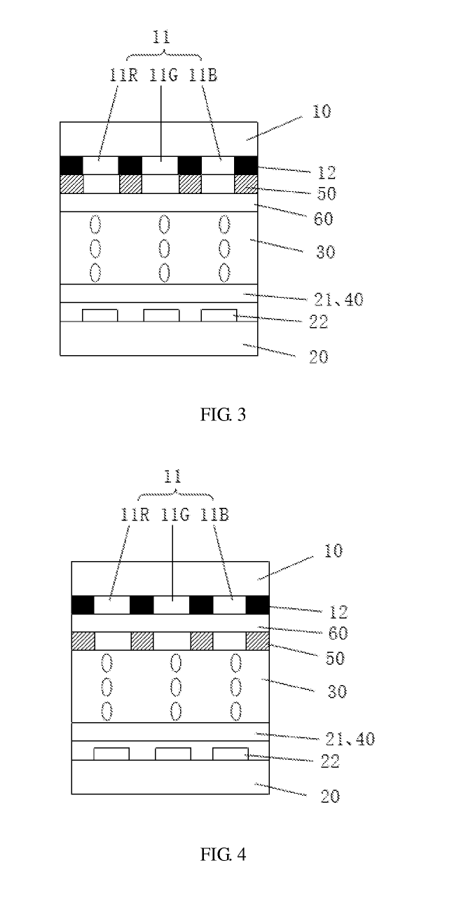

As shown in FIG. 3, an in-cell capacitive touch screen provided by the second embodiment includes an array substrate 20 having a common electrode layer 21, a color-filter substrate 10 having a array of filter cells 11 and disposed opposite to the array substrate 20, and a liquid crystal layer 30 sandwiched between the array substrate 20 and the color-filter substrate 10. The array of filter cells includes a plurality of filter cells 11. The filter cells 11 may include red filter cells 11R, green filer cells 11G and blue filter cells 11B. The array substrate 20 includes a pixel cell array 22 corresponding to the array of filter cells of the color-filter substrate 10. The color-filter substrate 10 further includes a black matrix to interval filter cells 11R, 11G, 11B in the array of filter cells 11. In this embodiment, the in-cell capacitive touch screen further includes a protecting layer 60 between the color-filter substrate 10 and the liquid crystal layer 30.

The touch electrodes of the touch screen may include driving electrodes 40 and sensing electrodes 50.

Specifically, the driving electrodes 40 are disposed in the common electrode layer 21 on the array substrate 20. That is, the common electrode layer 21 is divided into long strips along a row direction of the pixel cell array 22, as the driving electrodes 40 of the touch screen. Furthermore, a material of the common electrode layer 21 may be ITO. Because the driving electrodes 40 is divided from the common electrode layer 21, in one frame picture display time, the driving electrodes 40 may transmit common electrode signals and touch scanning signals time divisionally.

The sensing electrodes 50 are disposed on the color-filter substrate 10. The sensing electrodes 50 extend along a column direction of the pixel cell array 22. In this embodiment, the sensing electrodes 50 are disposed on the black matrix 12 and sandwiched between the color-filter substrate 10 and the protecting layer 60. Specifically, the sensing electrodes 50 are disposed between the black matrix 12 and the protecting layer 60. Furthermore, the sensing electrodes 50 may be metal electrodes. The metal electrodes may include laminated Mo/Al/Mo metal layers. In this embodiment, the sensing electrodes 50 may be transparent conductive oxide electrodes. For example, the transparent conductive oxide may be ITO.

### Third Embodiment

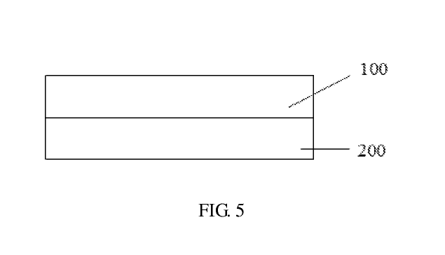

As shown in FIG. 4, an in-cell capacitive touch screen provided by the second embodiment includes an array substrate 20 having a common electrode layer 21, a color-filter substrate 10 having a array of filter cells 11 and disposed opposite to the array substrate 20, and a liquid crystal layer 30 sandwiched between the array substrate 20 and the color-filter substrate 10. The filter cells 11 include red filter cells 11R, green filer cells 11G and blue filter cells 11B. The array substrate 20 includes a pixel cell array 22 corresponding to the array of filter cells of the color-filter substrate 10. The color-filter substrate 10 further includes a black matrix to interval filter cells 11R, 11G, 11B in the array of filter cells. In this embodiment, the in-cell capacitive touch screen may further include a protecting layer 60 between the color-filter substrate 10 and the liquid crystal layer 30.

The touch electrodes of the touch screen may include driving electrodes 40 and sensing electrodes 50.

Specifically, the driving electrodes 40 are disposed in the common electrode layer 21 above the array substrate 20. That is, the common electrode layer 21 is divided into long strips along a row direction of the pixel cell array 22, as the driving electrodes 40 of the touch screen. Furthermore, a material of the common electrode layer 21 is ITO. Because the driving electrodes 40 is divided from the common electrode layer 21, in one frame picture display time, the driving electrodes 40 may transmit common electrode signals and touch scanning signals time divisionally.

The sensing electrodes 50 are disposed on the color-filter substrate 10. The sensing electrodes 50 extend along a column direction of the pixel cell array 22. In this embodiment, the sensing electrodes 50 are disposed on the black matrix 12, sandwiched between the liquid crystal layer 30 and the protecting layer 60 and disposed on the protecting layer 60. Furthermore, the sensing electrodes 50 may be metal electrodes. The metal electrodes may include laminated Mo/Al/Mo metal layers. In this embodiment, the sensing electrodes 50 may be transparent conductive oxide electrodes, such as ITO.

### Fourth Embodiment

As shown in FIG. 5, a display device provided by the fourth embodiment includes a screen 100 and a backlight 200. The screen 100 and the backlight module 200 are disposed opposite to each other. The backlight module 200 supplies a light source to the screen 100 to make the screen 100 present a picture. The screen 100 is an in-cell capacitive touch screen provided by above embodiments.

In summary, the in-cell capacitive touch screen provided in the embodiments, the driving electrodes are disposed on the array substrate, the sensing electrodes are disposed on the color-filter substrate, On the array substrate, only need to add the process for the preparation of driving electrodes, thereby reducing the difficult process of products, improving product yield, and saving the cost of production. In addition, The common electrode layer on the array substrate is divided into a plurality of strips, as driving electrodes, in one frame picture display time, the driving electrodes are configured to transmit common electrode signals and touch scanning signals time divisionally, thereby reducing the difficult process of products, improving product yield, and saving the cost of production.

It can be understood that, the forms “first,” “second,” used in the description of the invention and the appended claims are intended to distinguish an entity or operation from another entity or operation It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An in-cell capacitive touch screen, comprising an array substrate having a common electrode layer, a color-filter substrate having a array of filter cells and disposed opposite to the array substrate, and a liquid crystal layer sandwiched between the array substrate and the color-filter substrate, and the array substrate comprising a pixel cell array corresponding to the array of filter cells of the color-filter substrate, wherein,
the common electrode layer comprises a plurality of driving electrodes extending along a row direction of the pixel cell array, in one frame picture display time, the driving electrodes are configured to transmit common electrode signals and touch scanning signals time divisionally:
the color-filter substrate further comprises a black matrix to interval filter cells in the array of filter cells, the color-filter substrate further comprises a plurality of sensing electrodes extending along a column direction of the pixel cell array, wherein projection of the sensing electrodes on the color-filter substrate overlap the corresponding columns of the black matrix.

2. The touch screen according to claim 1, wherein the sensing electrodes and the corresponding columns of the black matrix are combined into one, thereby the sensing electrodes and the black matrix being in a same layer structure, and the black matrix between two columns of the filter cells is replaced by the sensing electrode.

3. The touch screen according to claim 1, further comprising a protecting layer disposed between the color-filter substrate and the liquid crystal layer, wherein the sensing electrodes are disposed on the black matrix, and sandwiched between the color-filter substrate and the protecting layer.

4. The touch screen according to claim 1, further comprising a protecting layer disposed between the color-filter substrate and the liquid crystal layer, the sensing electrodes are disposed on the black matrix and between the liquid crystal layer and the protecting layer.

5. The touch screen according to claim 1, wherein the sensing electrodes are metal electrodes.

6. The touch screen according to claim 5, wherein the metal electrodes comprise laminated Mo/Al/Mo metal layers.

7. The touch screen according to claim 3, wherein the sensing electrodes are transparent conductive oxide electrodes, the transparent conductive oxide is ITO.

8. The touch screen according to claim 4, wherein the sensing electrodes are transparent conductive oxide electrodes, the transparent conductive oxide is ITO.

9. The touch screen according to claim 1, wherein a material of the common electrode layer comprises ITO.

10. The touch screen according to claim 1, wherein the array of filter cells comprises red filter cells, green filter cells, and blue filter cells.

11. A display device, comprising a screen and a backlight module, the screen and the backlight module disposed opposite to each other, the backlight module supplying a light source to the screen to make the screen present a picture, wherein, the screen is an in-cell capacitive touch screen, the in-cell capacitive touch screen comprises an array substrate having a common electrode layer, a color-filter substrate having a array of filter cells and disposed opposite to the array substrate, and a liquid crystal layer sandwiched between the array substrate and the color-filter substrate, and the array substrate comprising a pixel cell array corresponding to the array of filter cells of the color-filter substrate, wherein,
the common electrode layer comprises a plurality of driving electrodes extending along a row direction of the pixel cell array, in one frame picture display time, the driving electrodes is configured to transmit common electrode signals and touch scanning signals time divisionally:
the color-filter substrate further comprises a black matrix to interval filter cells in the array of filter cells, the color-filter substrate further comprises a plurality of sensing electrodes extending along a column direction of the pixel cell array, wherein projection of the sensing electrodes on the color-filter substrate overlap the corresponding columns of the black matrix.

12. The display device according to claim 11, wherein the sensing electrodes and the corresponding columns of the black matrix are combined into one, thereby the sensing electrodes and the black matrix being in a same layer structure, and the black matrix between two columns of the filter cells is replaced by the sensing electrode.

13. The display device according to claim 11, further comprising a protecting layer disposed between the color-filter substrate and the liquid crystal layer, wherein the sensing electrodes are disposed on the black matrix, and sandwiched between the color-filter substrate and the protecting layer.

14. The display device according to claim 11, further comprising a protecting layer disposed between the color-filter substrate and the liquid crystal layer, the sensing electrodes are disposed on the black matrix and between the liquid crystal layer and the protecting layer.

15. The display device according to claim 11, wherein the sensing electrodes are metal electrodes.

16. The display device according to claim 15, wherein the metal electrodes comprise laminated Mo/Al/Mo metal layers.

17. The display device according to claim 13, wherein the sensing electrodes are transparent conductive oxide electrodes, the transparent conductive oxide is ITO.

18. The display device according to claim 14, wherein the sensing electrodes are transparent conductive oxide electrodes, the transparent conductive oxide is ITO.

19. The display device according to claim 11, wherein a material of the common electrode layer comprises ITO.

20. The display device according to claim 11, wherein the array of filter cells comprises red filter cells, green filter cells, and blue filter cells.
